(19) United States
(12) Patent Application Publication
(10) Pub. No.: US 2026/0317031 A1
(43) Pub. Date: Oct. 15, 2026

(54) BUBBLE FILM STRUCTURE

(71) Applicant: Naci Tamer ÖZERDEN, Istanbul (TR)

(72) Inventor: Naci Tamer ÖZERDEN, Istanbul (TR)

(21) Appl. No.: 18/877,140

(22) PCT Filed: Dec. 11, 2023
(86) PCT No.: PCT/TR2023/051511

§ 371 Date: Dec. 19, 2024

(51) Int. Cl. B65D 81/02; B32B 3/12; B32B 7/12; B32B 27/10; B32B 27/32

(52) U.S. Cl. CPC B65D 65/44; B32B 3/12; B32B 7/12; B32B 27/10; B32B 27/32; B32B 2250/03; B32B 2255/12; B32B 2255/205; B32B 2307/56; B32B 2553/026

(57) ABSTRACT

The invention relates to a PE packaging film structure with air bubbles for protecting the materials contained therein against undesirable conditions such as impact, vibration and heat loss.

### TECHNICAL FIELD

The invention relates to a PE packaging film structure with air bubbles for protecting the materials contained therein against undesirable conditions such as impact, vibration and heat loss.

### STATE OF THE ART

The products used in the technical field are called air bubble PE packaging films, which are produced by laminating a metallised surface on both sides of small air cells. In addition, there are also products produced with a PE foam layer in the field. The thickness of the air gap in these products is only 4-5 millimetres. In this situation, it is far below the minimum distance of 15-20 millimetres. In the prior art, in another application developed to provide a solution to said problem, only thin reflective covers with limited effect against radiation (radiance) are used. It does not provide any protection against heat effects in the form of conduction (transmission) and convection (transportation).

Many of the products in use in the state of the art do not provide protection against impacts, vibrations and, in short, physical hazards to which the products may be exposed during transport. In the prior art, users buy blown air bubble PE packaging film in roll, sheet and bag form and use it according to their needs. This situation brings a serious space covering, storage problems and storage costs. There are also disadvantages for different uses. For example, a large product needs to have different sizes for coating, different sizes for a package or envelope. Each of these creates separate costs and separate storage problems. Users have to use different types of materials for different products (large and small bubble, more flexible, or thicker, heat-resistant, sun-proof, flexible, flexible, barrier feature) and have to be stored separately. In addition, in terms of carbon emission, it causes more raw material production and energy use, space and labour costs. Nowadays, the cost of transport, and warehouses seriously increases employee costs.

The increase in transport and storage costs, especially after the pandemic period, has brought the necessity of innovation here.

As a result, due to the above-mentioned disadvantages and the inadequacy of the existing solutions, a development in the relevant technical field has become necessary.

### BRIEF DESCRIPTION OF INVENTION

The present invention relates to an air bubble PE packaging film structure which meets the above-mentioned requirements, eliminates all disadvantages and provides some additional advantages.

The invention is inspired by the present situation and aims to solve the above-mentioned disadvantages.

The main purpose of the invention is to provide a heat insulation function in accordance with the purpose of preventing undesirable situations such as deterioration and loss of freshness of heat sensitive products during transport. The invention provides that the temperature inside the parcel remains relatively constant or fluctuates minimally so that the parcel contents are minimally damaged by external temperature changes. In the invention, a more environmentally friendly product is obtained since the amount of plastic will be reduced by the amount of paper to be added in situation of paper use.

Another purpose of the invention is to protect the products in the parcel against impacts, vibrations and, in short, physical hazards to which the products may be exposed during transport. The inventive bubble film structure has cushioning and protective properties by filling the gaps. The flexibility provided by the air cells in the invention protects the products against impacts, vibrations and, in short, physical hazards to which the products may be exposed during transport. For example, ten times or more products can be sent in the same unit area when sent without inflation, compared to insulated packages that are inflated during transport.

Another purpose of the invention is to obtain a structure having the feature of filling the gaps in the parcel. By means of filling the gaps in the parcel, the free movement of the products in the parcel during transport is prevented and protection is provided, and damage is prevented. The field of use of the invention is not limited to applications in parcels. It is suitable for use as a cargo bag or integrated into the cargo bag and as a pallet cover or integrated into the pallet cover and similar areas.

Differently from the state of the art, the bubble film structure of the invention is separately effective against conduction (transmission), convection (transportation) and radiation (radiance) mechanisms, which are the three forms required by the heat insulation mechanism.

Another purpose of the invention is to provide heat insulation with a single product without having to use different types of materials. The invention adds a barrier feature and provides protection against heat effects in the form of conduction (transmission) and convection (transportation) by means of the air cells.

Another purpose of the invention is to save about 90% in transport, handling and storage costs. In the invention, balloon shapes and sizes can be in different patterns and sizes.

The air cells, which are one of the components of the invention and provide heat insulation, cushioning and space filling, are supplied and shipped deflated and inflated to the final application point. Thus, the procurement of the inventive materials is very easy, low cost and practical. Transport and storage costs are minimised due to the inflation of the products at the final application point. Since the inventive bubble film structure fulfils the function of more than one different product alone, the product is saved. This contributes to minimising carbon emissions. In addition, products are currently purchased as inflated and stored in this way. However, this product can be purchased either inflated or uninflated as metallised coated. Since it does not take up space because it is not inflated, much more products can be stored in the unit area in transport and storage. In addition, when the product is taken without inflated, it can meet every need by means of the fact that it can be cut and used in desired sizes. The user can inflate and use as much as they will use and store the rest again.

Radiation (radiance) heat insulation is the most effective system among the existing products, especially as a barrier and reflector. This efficiency is provided by the thickness of the air gap between the two metallised surfaces. For effective radiation heat insulation barrier and reflectivity, there should be an air gap of at least 15-20 millimetres in front of and behind the reflective metallised surfaces. In the invention, the air gap provides this distance. In situations where the distance is less, the barrier providing radiation (radiance) heat insulation and reflectivity feature decreases considerably.

The structural and characteristic features and all advantages of the invention will be more clearly understood by means of the figures given below and the detailed description written by making references to these figures, and therefore, the evaluation should be made by taking these figures and detailed description into consideration.

### FIGURES TO HELP UNDERSTANDING THE INVENTION

In order to provide the best understanding the structure and advantages of the present invention, it should be evaluated together with the figures described below.

FIG. 1 shows the layers before the metallisation process, the metallised surface and the PE packaging film layer with air bubbles.

FIG. 2 shows the three-layered structure of the inventive final product after metallisation.

FIG. 3 shows the final product of the invention before the balloons are inflated.

FIG. 4 shows the final product of the invention after the balloons have been inflated and its zoomed view.

FIG. 5 shows the general view of the inventive final product containing paper.

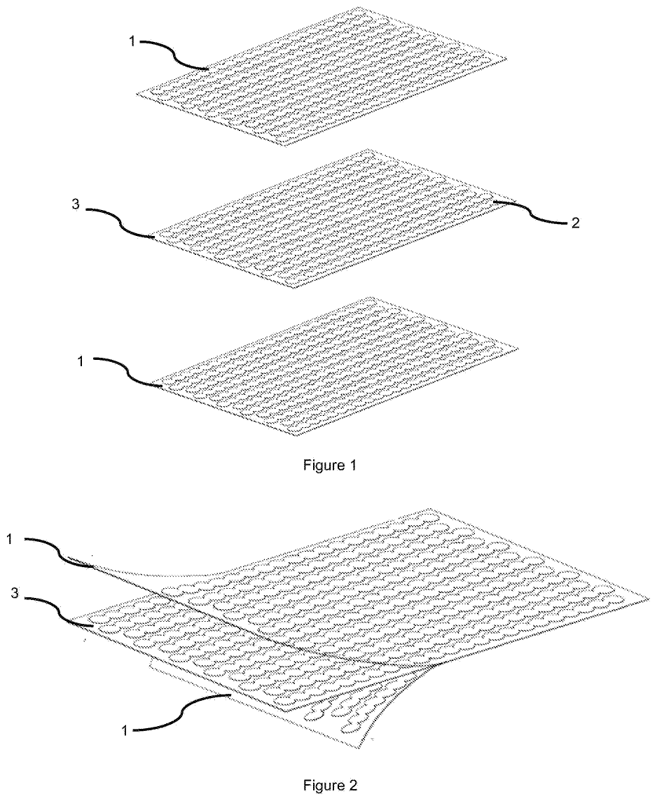

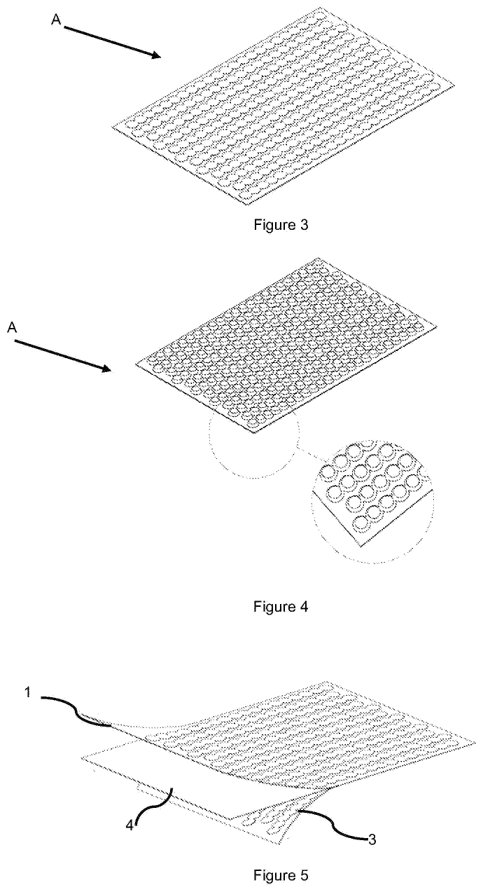

### PART REFERENCES

1 Metallised surface
2 Balloon
3 Air bubble layer
4 Paper

### DETAILED DESCRIPTION OF THE INVENTION

In this detailed description, the preferred embodiments of the invention are described only for the purpose of a better understanding of the subject matter.

The invention relates to a bubble film structure (A) for protecting the materials contained therein against undesirable conditions such as impact, vibration and heat loss. The inventive bubble film structure (A) comprises at least one air bubble layer (3). Said air bubble layer (3) is a layer made of nylon material on which there are many balloons (2) of the same and/or different sizes and which fulfils the protection function. There is at least one metallised surface (1) at the top and bottom of the air bubble layer (3). In this situation, the air bubble layer (3) is covered from the top and bottom with a metallised surface (1). Said air bubble layer (3) is preferably polyethylene.

In an alternative embodiment of the invention, at least one paper (4) may be provided between the metallised surface (1) and the air bubble layer (3).

The inventive bubble film structure (A) is in the form in which at least one or two surfaces are metallised, which can be stored, transported and used with or without being inflated. The bubble film structure (A) may be in the form of a roll sheet or a bag after inflation.

The process of combining metallised surfaces (1) with the air bubble layer (3), which can be in different balloon (2) sizes, by laminating the air bubble layer (3) on one side or in two layers from the bottom and top. In the state of the art, the metallisation process is carried out on the air bubble layer (3) after the balloons (2) are inflated in the machine. However, in the bubble film structure (A), metallised coating lamination can be performed without inflating the balloons (2). This facilitates and accelerates the process and increases durability. Optionally, it can be used in uninflated form or transported and stored. Alternatively, the inflation can be performed by inflating balloons (2) at the end-use location and at the time of use.

For effective radiation heat insulation barrier and reflectivity, reflective metallised surfaces (1) must have an air gap of at least 15-20 millimetres in front of and behind them. By means of this thick air gap, it provides much more protection against heat effects in the form of conduction (transmission) and convection (transportation).

The metallised surface (1) used in the invention can be metallised directly to the balloon patterned polyethylene film to be inflated or any metallised film (PP, PET, PE) can be combined with the balloon patterned polyethylene film to be inflated by heat or glue. In different embodiments of the invention, it is possible to use all three techniques mentioned in accordance with the requirements.

In the invention, if desired, metallised coating can be applied on one side of the paper (4) by spraying. The other surface of the paper (4) can be coated with polyethylene by pouring or gluing. FIG. 4 shows a zoomed-in view of the inventive final product after the balloons have been inflated. Accordingly, the balloons (2) are connected to each other. Therefore, when inflating, all balloons (2) are inflated as they start to be inflated from a single side.

1. A bubble film structure to protect the materials inside against undesirable situations such as impact, vibration, and heat loss, comprising:
at least one air bubble layer with a plurality of balloons of same and/or different sizes and configured to fulfil the protection function; and
at least one metallised surface located at top and bottom of the air bubble layer.

2. The bubble film structure according to claim 1, wherein the air bubble layer is polyethylene.

3. The bubble film structure according to claim 1, further comprising at least one paper between the metallised surface and the air bubble layer.

4. The bubble film structure according to claim 1, wherein the bubble film structure is in blown form.

5. The bubble film structure according to claim 1, wherein the bubble film structure is in unblown form.

6. The bubble film structure according to claim 4, wherein the bubble film structure is in roll sheet or bag form.

7. The bubble film structure according to claim 1, wherein the metallised surfaces have an air gap of at least 15 to 20 millimetres in front and behind.

8. The bubble film structure according to claim 1, wherein the metallised surface is in the form of a bubble patterned polyethylene film to be inflated, either by direct metallisation of the bubble patterned polyethylene film to be inflated or by bonding any metallised film to the bubble patterned polyethylene film to be inflated by heat or glue.

9. The bubble film structure according to claim 3, wherein the metallised surface is in sprayed form on one surface of the paper and a polyethylene coating is applied by casting or adhesive on the other surface of the paper.
